(19) United States
(12) Patent Application Publication
(10) Pub. No.: US 2003/0113047 A1
(43) Pub. Date: Jun. 19, 2003

(54) Trunnion bearing for the cradle carrier of a large-caliber weapon tube

(76) Inventors: Berthold Baumann, Eschede (DE); Hartmut Wagner, Unterluss (DE)

Correspondence Address: VENABLE, BAETJER, HOWARD AND CIVILETTI, LLP, P.O. BOX 34385, WASHINGTON, DC, 20043-9998, US

(21) Appl. No.: 10/013,655

(22) Filed: Dec. 13, 2001

(30) Foreign Application Priority Data
Dec. 13, 2001 (DE) 100 62 210.0

(51) Int. Cl. F16C 19/54

(52) U.S. Cl. 384/455

(57) ABSTRACT

A bearing assembly for the cradle trunnions of a weapon barrel includes an axial bearing for taking up axial forces and a radial bearing for taking up radial forces. As radial bearings toroidal roller bearings are used.

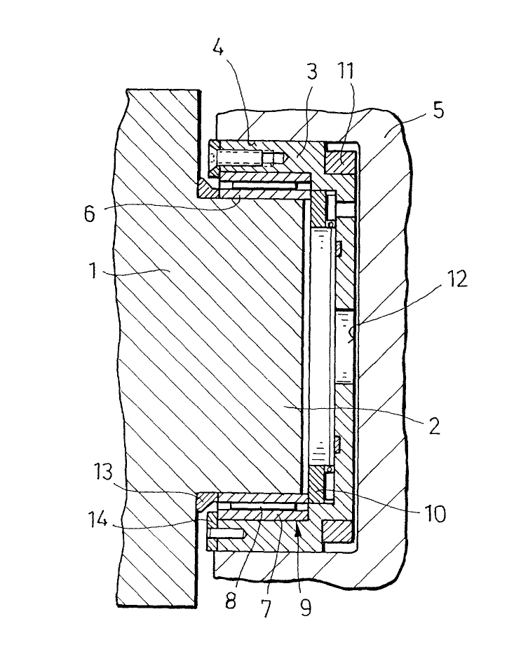

### CROSS REFERENCE TO RELATED APPLICATION

This application claims the priority of German Application No. 100 62 210.0 filed Dec. 13, 2000, which is incorporated herein by reference.

### BACKGROUND OF THE INVENTION

This invention relates to a trunnion bearing assembly for the cradle carrier of a large-caliber weapon tube. The bearing assembly includes bearing housings which are situated on both sides of the cradle frame and which serve for receiving the trunnions affixed to the cradle frame. Each bearing housing accommodates at least one roller bearing for taking up radial forces and one axial bearing for taking up axial forces.

A trunnion bearing of the above-outlined type is disclosed, for example, in German Patent No. 3,146,165, to which corresponds U.S. Pat. No. 4,531,447. According to this patent cylinder roller bearings are used as radial bearings. It has been found, however, that stringent requirements on the manufacturing accuracy of the radial bearings have to be set, because significant frictional losses may occur in the bearings in case of alignment errors in the trunnions or their receiving components. Such frictional losses require high rectifying forces. Further, radially oriented forces applied to the trunnions involve additional stresses on the cradle frame; these may adversely affect the impact accuracy of the weapon.

### SUMMARY OF THE INVENTION

It is an object of the invention to provide an improved trunnion bearing assembly of the above-outlined type, using radial force-absorbing bearings which, despite small spatial requirements, compensate for alignment errors in the trunnions or their receiving components without exerting additional stresses on the cradle frame.

This object and others to become apparent as the specification progresses, are accomplished by the invention, according to which, briefly stated, the bearing assembly for both cradle trunnions of a weapon barrel includes an axial bearing for taking up axial forces and a radial bearing for taking up radial forces. As radial bearings toroidal roller bearings are used.

### BRIEF DESCRIPTION OF THE DRAWING

The sole FIGURE is an axial sectional view of a preferred embodiment of the invention.

### DESCRIPTION OF THE PREFERRED EMBODIMENT

The sole FIGURE shows, in longitudinal section, a trunnion bearing assembly arranged on both sides of a cradle carrier 1 which surrounds a non-illustrated cradle tube in which the weapon barrel is supported. The FIGURE and the present description relate to the bearing assembly on one side of the cradle carrier; the bearing assembly on the opposite side is of identical structure. A trunnion 2 affixed to the cradle carrier 1 is received by a bearing housing 3 arranged in a bearing well 4, of, for example, the turret 5 of a tank or the carriage of a cannon.

For taking up radial forces, according to the invention the bearing housing 3 accommodates a toroidal roller bearing 9, composed of an inner race 6, and outer race 7 and toroidal rolling bodies (rollers) 8. In practice, particularly the CARB-model toroidal roller bearings manufactured by the firm SKF have been proven satisfactory because they have a low structural height, they compensate for axial shifts in the bearing up to 10% of the bearing width and also compensate for misalignments between housing and shaft—and compensate for alignment errors of the trunnions and their receivers—up to 1%, while the load on the rollers still remains uniformly distributed. The housing 3 also contains a conventional axial bearing 10 for taking up axial forces.

For adjusting the axial position of the weapon barrel and for minimizing the bearing play of the axial bearing 10, a conventional adjustable threaded ring 11 is provided which engages the inner wall 12 of the bearing well 4 of the turret 5. Such a threaded ring is disclosed in the earlier-noted U.S. Pat. No. 4,531,447.

The securement of the toroidal roller bearing 9 is ensured by shrunken seats, by means of which the inner race 6 is secured to the trunnion 2 and the outer race 7 is secured to the bearing housing 3. Further, the inner race 6 of the toroidal roller bearing 9 is axially spaced from the cradle carrier 1 by a support ring 13. The outer race 7 of the toroidal roller bearing 9 is immobilized in the bearing housing 3 by a securing disk 14 in such a manner that the inner race 6 may shift or tilt with respect to the outer race 7 in order to compensate for alignment errors of the trunnions 2 or the bearing wells 4.

It will be understood that the above description of the present invention is susceptible to various modifications, changes and adaptations, and the same are intended to be comprehended within the meaning and range of equivalents of the appended claims.

What is claimed is:

1. A bearing assembly for the cradle trunnions of a weapon barrel, comprising an axial bearing for taking up axial forces and a radial bearing for taking up radial forces; said as radial bearings toroidal roller bearings are used.
